(19) United States
(12) Patent Application Publication
(10) Pub. No.: US 2004/0049779 A1
(43) Pub. Date: Mar. 11, 2004

(54) Interactive television

(76) Inventors: Johan Sjoblom, Vora (FI); Alex D'Anci, Vaasa (FI); Stefan Standberg, Vora (FI)

Correspondence Address: JENKENS & GILCHRIST, PC, 1445 ROSS AVENUE, SUITE 3200, DALLAS, TX, 75202, US

(21) Appl. No.: 10/451,209

(22) PCT Filed: Dec. 18, 2001
(86) PCT No.: PCT/EP01/15052

(30) Foreign Application Priority Data
Dec. 20, 2000 (GB) 0031236.3
Dec. 20, 2000 (GB) 00312237.1

(51) Int. Cl. H04N 7/16; H04H 9/00; H04N 7/025; H04N 7/10

(52) U.S. Cl. 725/13; 725/34; 725/35

(57) ABSTRACT

A method of enabling a television viewer to interact with a television programme. A television signal corresponding to said television programme is broadcast by a television corporation 1 whilst an information server 5 is synchronised to the broadcast. Messages are sent from the information server 5 to a mobile wireless terminal 7 operated by the television viewer and/or received messages received at the information server 5 from wireless terminal 7. The sending and/or receipt of messages at the information server 5 is synchronised with the broadcast television signal.

### FIELD OF THE INVENTION

The present invention relates to interactive television and in particular to a method and apparatus for enabling information, including text and multimedia data, to be exchanged between individual viewers and a television broadcaster.

### BACKGROUND TO THE INVENTION

There exists a demand amongst television viewers, broadcasters, and advertisers for interactive television (iTV). Interactive television will allow individual viewers to participate in television shows, for example as contestants in a game show, without having to attend the studio where the show is being produced, and will allow viewers to request and receive tailored supplementary information (which may be multimedia data) which it is not possible to provide via a conventional terrestrial, satellite, or cable broadcast. Using iTV, broadcasters and advertisers will be able to expand the range of available services, tapping into and collecting information from niche markets.

Interactive television is available today to a very limited extent. One approach is to broadcast multiple channels of information. The channels are decoded by a set top box, and the user may select one or more of the channels for viewing. Using this method, it is possible for example to allow a viewer to select one of several possible camera angles during a televised football match. Another approach requires the provision of a set top box which is connected to the viewer's telephone line. A viewer's selection (or other data) is returned via the phone line to a central server of the television broadcaster. Data may be returned to the viewer via the same phone line or via the broadcast channel.

A problem with both of the above approaches is that they require the use of a set top box. The penetration of such set top boxes is, and is likely to remain, low. Furthermore, a method which relies upon a set top box tends not to be viewer specific. For example, it is not possible for several viewers of the same television to interact differently with a given programme.

### STATEMENT OF THE INVENTION

It is an object of the present invention to overcome or at least mitigate the above noted disadvantages of existing interactive television systems. In particular, it is an object of the present invention to provide an interactive television system which is personalised to an individual viewer.

These and other objects are achieved by providing an information server which is synchronised with television broadcasts and which exchanges information with mobile wireless terminals of individual viewers.

According to a first aspect of the present invention there is provided a method of enabling a television viewer to interact with a television programme and comprising the steps of:

broadcasting a television signal corresponding to said television programme; and

sending messages from an information server to a mobile wireless terminal operated by said television viewer and/or receiving messages at the information server sent from said wireless terminal, the sending and/or receipt of messages being synchronised at the information server with the broadcast television signal.

The mobile wireless terminal is preferably able to communicate with and via a mobile telecommunications network. Such a network may be, for example, a GSM network with GPRS enhancement or a third generation network such as a UMTS network.

Preferably, messages are sent between the information server and the mobile wireless terminal using Internet Protocol (IP)—a message may comprise one or a sequence of IP datagrams. The Wireless Application Protocol (WAP) or other wireless web service may be used to optimise data transmission. A viewer may establish an initial connection to the information server using a URL which is displayed on the television being viewed, or presented on some other media such as a television listing magazine, newspaper, or billboard. Alternatively, the URL of a television channel's home page may be pre-stored in the viewer's phone, or may be sent to the phone via the mobile network or from the television using infra-red or Bluetooth technology. After a connection has been established, URLs pointing to programme specific content may be sent to the viewer's terminal. The viewer then has the option whether or not to follow the sent links. The communication between the mobile terminal and the information server may be based on a client server type interface rather than the use of URLs. The information server may perform a redirection operation on a viewer URL request, to a third party web server.

In the case of “always on” connections, such as will be available with the introduction of the GPRS enhancement of GSM and with third generation networks, there may be no need to establish a connection in the first instance. As long as the terminal is switched on, URLs and/or programme specific content may be pushed to a viewer's terminal.

As an alternative to DP, messages may be sent between the information server and the mobile wireless terminal using text messaging, e.g. the Short Message Service (SMS) of GSM.

It will appreciated that synchronisation between the information server and the broadcast television signal may be achieved automatically, by including programme start and end triggers in the broadcast signal, or manually by an operator viewing the relevant television channel.

The method of the present invention may be used to send location specific messages to a mobile wireless terminal. A mobile telecommunication network is able to identify the location of use of a mobile terminal, for example based upon the Location Area (LA) registered for the terminal in the HLR or VLR of the network. Future networks such as UMTS networks, will be able to pinpoint the location of a terminal with much greater accuracy. By making this location available to the information server, content can be selected which is specific to the location. This may be particularly relevant where a given channel broadcasts different programmes in different regions.

In certain embodiments of the present invention, a viewer may select which content to view on a television using a mobile wireless terminal. Options are displayed on the terminal, with selection messages being sent from the terminal to the information server via the mobile telecommunications network. The signal broadcast to the viewer depends upon the selection(s) made by the viewer. Following a selection, a new set of options may be sent to the mobile wireless terminal via the mobile telecommunications network.

The mobile wireless terminal may function as a television remote control using for example infra-red or radio signals. Addresses for connecting to the information server may be associated with respective programme selection buttons. For example, where the mobile terminal communicates with the information server using IP, the numerical keys of the terminal may each be associated with a URL. Of course URLs may be similarly associated with channel selection operations which require multiple key presses. When a key is pressed (or keys pressed) to select a particular channel, the terminal will establish a connection to the corresponding URL.

According to a second aspect of the present invention there is provided a method of accessing a www page relevant to a broadcast television programme, the method comprising:

selecting a television channel by pressing a button or buttons of a wireless communication terminal to cause a channel selection signal to be sent from the terminal to a television,

the button press(es) causing the mobile terminal to establish a connection to an information server via a mobile telecommunication network, and transferring the relevant www page from the server to the terminal over said connection.

It will be understood that the wireless terminal doubles as a television remote control and a mobile wireless terminal capable of communicating with the information server using IP.

According to a third aspect of the present invention there is provided apparatus for enabling a television viewer to interact with a television programme and comprising:

an information server synchronised to one or more television broadcasts; and

means for exchanging information between the information server and a multiplicity of mobile wireless terminals via a mobile telecommunications system.

The mobile wireless terminals in communication with the information server may be mobile telephones or communicators, or a PDAs having wireless communication functionality. It will be appreciated that the mobile terminal need not have any speech capacity so could be a palmtop or laptop computer or the like having a GSM card. Other terminal types can also be envisaged.

According to a fourth aspect of the present invention there is provided a method of determining a profile of the audience of a broadcast advertisement, the method comprising:

enabling audience members to send their identity or location to the broadcaster of the advertisement or to a merchant in substantially real time when viewing or listening to the advertisement; and

automatically collecting and processing sent information to provide a profile of the audience.

The term “merchant” as used herein is intended to cover distributors, manufacturers etc. of products, and providers of services.

Preferably the collection of sent information is synchronised to the broadcast.

Preferably the advertisement is broadcast using a satellite, cable or terrestrial TV broadcast and audience members can send their identity or location to the merchant or broadcaster through an interactive feedback channel via a mobile wireless terminal and a mobile network. The mobile network may be a third generation network (e.g. UMTS) or may be a GSM network providing a packet switched service (e.g. GPRS). The interactive feedback channel preferably uses IP.

The mobile wireless terminal may use WAP. If connected to another network, e.g. PDC, the mobile wireless terminal may use i-mode.

The location of the viewer may be determined from the location of the terminal in the network.

Alternatively the interactive feedback channel may be via a telephone connection between an audience member's set top box and a broadcaster or merchant, or via a separate stand-alone telephone connection.

In another alternative, feedback may be via the Internet, again between a set top box or a stand-alone IP connection.

Each set top box may have associated with it a unique identifier which is communicated to the merchant, so that the identity or location of each viewer may be determined by the merchant from the identifier of the set top box.

The method may be such that an audience member triggers the sending of a message to the broadcaster or merchant. Of course, in other embodiments, the identity or location of an audience member may be communicated automatically to the broadcaster or merchant each time the advertisement is broadcast.

The profile of the audience may provide information about the demographics (age, income, etc) of the audience. It may alternatively or also provide information about the location of the audience.

According to a fifth aspect of the present invention there is provided a method of advertising products or services, comprising:

broadcasting a first advertisement;

obtaining a profile of the audience of the first advertisement in substantially real time using the method described above;

selecting a second advertisement based on the profile of the audience of the first advertisement; and

broadcasting the second advertisement.

According to a sixth aspect of the present invention there is provided a method of distributing products and services, comprising:

broadcasting an advertisement for the products or services;

determining the location of the audience of the advertisement in substantially real time using the method described above; and

providing the advertised products or services in locations indicated by the location of the audience of the broadcast advertisement.

The advent of interactive television and radio enables merchants to determine demographic profiles of an audience in real-time. If a merchant knows the demographics (location, age group, income, buying habits, etc.) of persons who are actually viewing or listening to their advertising, they can tailor the delivery of goods to real stores in a “just-in-time” (JIT) manner to better match the current regional demographics of the audience/consumers who have actually seen/heard the advertisements. In other words, this real-time demographic data can be used to determine what products to ship and stock on store shelves in the days following the broadcast of the commercial.

### BRIEF DESCRIPTION OF THE DRAWINGS

FIG. 1 illustrates schematically a system for providing interactive television;

FIG. 2 is a flow diagram illustrating a method of operation of the system of FIG. 1;

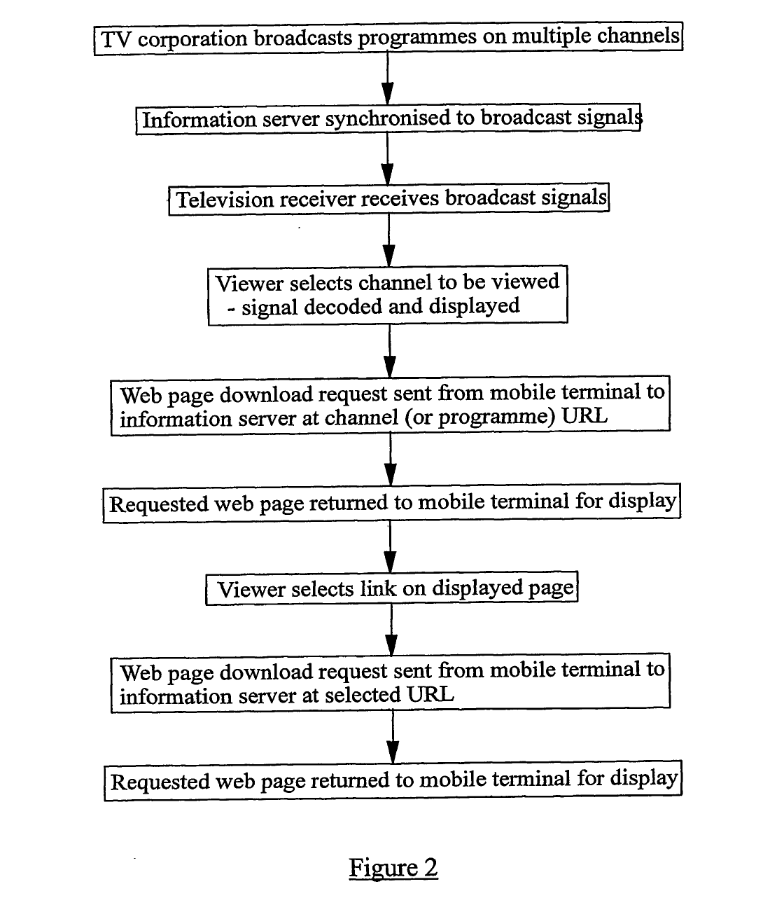

FIG. 3 illustrates schematically an alternative system for providing interactive television;

FIG. 4 illustrates schematically a further alternative system for providing interactive television; and

FIG. 5 is a flow diagram illustrating a method of collecting audience information using interactive television.

### DETAILED DESCRIPTION OF A PREFERRED EMBODIMENT

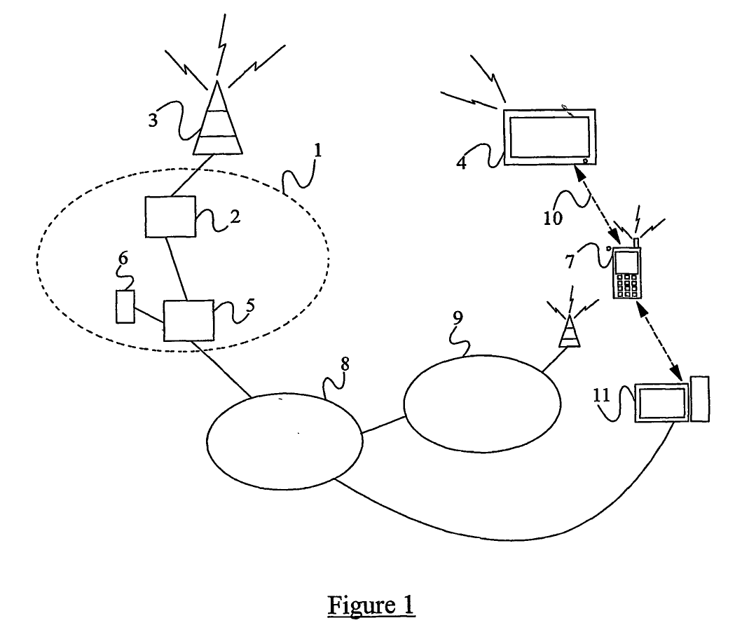

There is illustrated in FIG. 1 a system for providing interactive television. A television corporation 1 broadcasts programmes on a number of different terrestrial television channels from a central studio or studios 2 using a set of transmitters 3. Televisions 4 receive the broadcast channels in the usual manner.

The interactive component of television viewing is facilitated by providing an information server 5 which is coupled to the broadcasting studios to receive the broadcast signals (the server may be provided by one or more computers). The broadcast signals contain programme triggers which indicate the beginning and end of a programme (including commercials) and possibly the identity of broadcast programmes. Triggers may also occur during a programme to indicate a specific event. The server 5 is coupled to a database 6 which stores a set of information for each programme to be broadcast (e.g. in a given week). This information is in the form of HTTP or WAP pages (coded using for example, HTML, Compact HTML, XHTML, NWL, and/or WML). The server 5 retrieves information from the database 6 according to the triggers contained in the broadcast signals.

A television viewer wishing to participate in an interactive broadcast must be in possession of a wireless device 7 such as a mobile telephone, communicator, or PDA. For the purpose of illustration, the wireless device 7 is assumed to have functionality for accessing the Internet 8 via a mobile telecommunication access network 9 to which the terminal user subscribes. Conventional mobile phone networks (e.g. GSM) may have this functionality. However, Internet access is currently being greatly enhanced by the introduction of services such as GPRS and new networks such as UMTS.

The viewer will select on the mobile terminal 7 the www address (URL) of the television channel (or programme) which he or she is currently viewing. This address may be displayed on the television screen and/or may be pre-programmed into the terminal 7. The selected URL identifies a location at the information server 5. The request for information is sent to the server 5 via the mobile network 9 and the Internet 8. The content at the specified location changes dynamically according to the programme triggers contained in the television signals received by the server 5 from the studio 2. The server 5 returns the current content of the specified location to the terminal 7. By including certain information in the headers of HTTP (and WAP) pages it is possible to force proxies which may be present in the transmission route between the server 5 and the terminal 7 (and at the terminal 7 itself) not to store these pages in their respective caches. This means that requested pages are always obtained from the information server 5, ensuring that the pages are always “fresh”. In some cases, the server 5 may redirect a URL request to some other URL, for example a URL of an e-commerce case in the case that a viewer has clicked a link during the broadcast of a commercial. The server 5 may record the redirection service for the later billing of the sponsor.

The returned page is displayed on a display of the terminal 7 and includes information relevant to the programme being viewed. The page may include farther hyperlinks which can be selected by the viewer. Client software or scripts (e.g. EPOC software or ECMAScript) in the wireless terminal 7 may be used to allow the viewer to send data to the server 5, for example answers to questions presented on a game show. The appropriate software or script may be either preinstalled or loaded over the Internet into the terminal 7. Secure exchange mechanisms implemented in a similar manner may allow e-commerce transactions such as betting on broadcast sporting events and the purchase of items advertised in commercials.

It is possible for information to be pushed from the server 5 to viewers' wireless terminals 7. In particular, it is possible to instruct terminals to download pages from the server 5 at a certain refresh rate, e.g. every 5 seconds.

Operators of existing mobile telephone networks already know the Location Area (i.e. the group of broadcast cells) in which the user of a mobile subscriber is located. Future networks will be able to pin-point the location of subscribers with a much greater degree of accuracy. By making this information available to the information server 5, it is possible for the server to return information (web pages) to the terminal 7 which is specific to the viewer's current location.

The present invention may be used to enable viewers to determine what is broadcast to their television. The availability of such a service will depend upon the available broadcast bandwidth. Even with a small bandwidth however, it is possible to allow viewers to take a “vote” on which information is to be broadcast. If the location of viewers is known to the information server 5, votes can be carried out area by area in the case that broadcasts are area specific. A given viewer may have control of a broadcast within his area for some predetermined period of time, before control is passed to another viewer in the same area.

The information which is sent from the information server 5 to a viewer's terminal 7 may be a subset of the information displayed on his television 4. For example, only selection menus and hyperlinks may be displayed on the terminal 7.

The interactive viewing process may be enhanced by enabling the mobile terminal 7 to function as a television remote control (using signalling indicated by the dashed line 10 in FIG. 1). In this way it is possible to ensure that the mobile terminal 7 “knows” which channel is being viewed by the viewer. It is also possible for the television 4 to send information to the terminal 7 if the link 10 is bi-directional (Bluetooth or infrared). For example, the television 4 may inform the terminal 7 of the channel which is currently selected.

The wireless terminal 7 has a TV “profile” which can be selected by the user. Under this profile the terminal 7 operates as a TV remote controller—all buttons on the terminal 7 work as TV remote control buttons. For example: “No” turns off the TV 4, digits select the corresponding channel, the side bar controls the TV volume etc. A long press of the YES button returns the terminal 7 back from the TV profile to the normal phone profile. An incoming call would also automatically turn of the TV profile for normal mobile phone call handling, and optionally mute the sound on the television for the duration of the call.

When the terminal 7 is in a learn mode, it can learn from a master device, such as the original TV remote controller. The terminal 7 can learn what to send on an infrared port (or bluetooth radio chip in the future) when the user simultaneously presses selected buttons on the terminal 7 and the master device, so that the terminal 7 will subsequently send the same signals as the original master device would have done with the same button presses.

When operating with the TV profile, channel selection buttons of the terminal 7 are associated with respective web addresses. For example, the digit buttons 0-9 are associated with respective television channels and web addresses (this can of course be extended to channels above 9—alternatively a list of favourite channels can be programmed as a selectable list each associated with a channel web address). When a channel is selected, the terminal 7 will contact the server 5 to obtain the web page associated with the selected channel (or the programme currently being broadcast on the selected channel).

The following are example steps of how to associate a web address with a TV channel on a mobile terminal:

1. Edit profile.

2. Name the profile “TV”, as this profile is going to integrate the TV remote control functionality into the terminal.

3. Choose the carrier for communication with the TV, e.g. infrared, or bluetooth radio chip.

4. Go to learn mode (the terminal now enters a learn mode during which it “listens” to the port selected in 3.

5. Go to “edit bookmark”. Here the user enters the web address that he/she wants to associate with a given channel. The user must also press a channel selection key on the terminal to bind the web address to that channel.

6. Send a sample signal to the terminal port (from the original remote controller) so that the terminal can learn the signal to relate to the channel selection key.

It will be appreciated that various modifications may be made to the above described embodiments without departing from the scope of the present invention. For example, whilst the television signals in the embodiments described above were broadcast via terrestrial transmitters, signals may alternatively or additionally be broadcast via satellite or sent over cables. In another modification, special software installed on a viewer's terminal may enable the viewer to interact with the broadcast. For example, the software may present a dedicated browser with navigation tools unique to a particular channel or programme. In yet another modification, a viewer's mobile terminal 7 may communicate with a PC (indicated by reference numeral 11 in FIG. 1) which is connected to the Internet via an always on connection. Information is downloaded from the information server 5 via the Internet and the PC to the mobile terminal 7. The terminal 7 may communicate with the PC 11 using for example an infrared, Bluetooth, or wireless LAN link.

There will now be described another aspect of the present invention which relates to the marketing and sale of products and services, and to the gathering of marketing data.

A market can be made aware of products and services via advertising channels such as television, radio, newspapers and magazines. Such channels are a form of mass media, and although providers of goods and services can reach a global market using such media, they have no immediate feedback as to who has been persuaded to buy the products or services as a result. The flow of information is in one direction only, from the advertiser to the consumer. Eventually, people may come into shops and buy products, at which stage it may be too late to ensure that any demand created by the advertising will be met.

One method of advertising a product on television is the “head and tail” system, in which two short advertisement films about the product are separated by other commercials. Normally the head, or first film, is a long commercial describing the product. The tail (second film) is broadcast after intervening related or unrelated commercials, and is targeted to re-enforce the core message of the first film. The second film is usually much shorter than the first. The impact of the head and tail system is enhanced if the tail can be tailored to the audience of the broadcast.

There is therefore a problem for merchants that without a profile of the audience of their advertisements they cannot tailor subsequent “tail” advertisements to those they know have watched the “head”, or ensure that there is sufficient supply in local stores to meet the demand created by advertisements in one particular area.

Interactive television (iTV) will allow individual viewers to participate in television shows, for example as contestants in a game show, without having to attend the studio where the show is being produced, and will allow viewers to request and receive tailored supplementary information (which may be multimedia data) which it is not possible to provide via a conventional terrestrial, satellite, or cable broadcast.

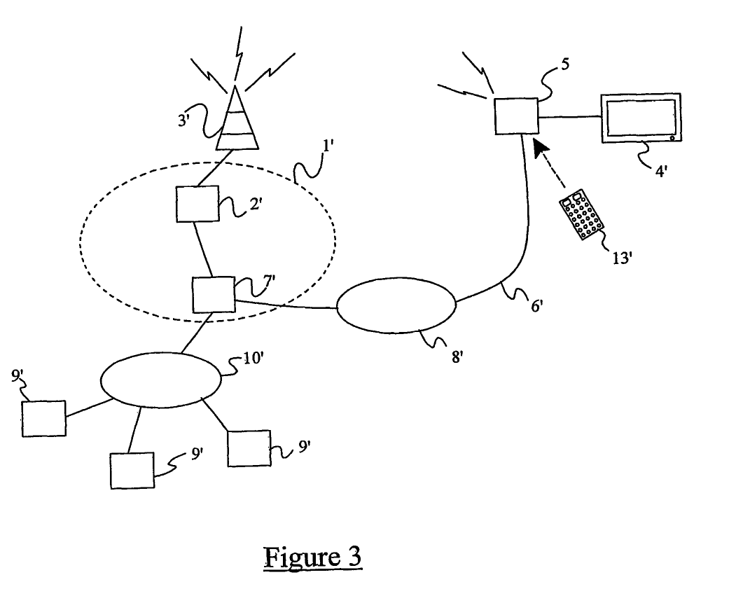

There is illustrated in FIG. 3 a system for providing interactive television. A television corporation 1′ broadcasts programmes on a number of different terrestrial digital television channels from a central studio or studios 2′ using a set of transmitters 3′. This is known as Digital Terrestrial Television (DTT). Alternatively, the programmes may be broadcast via a satellite or cable (not shown). Televisions 4′ receive the broadcast channels via set top boxes 5′, which decode the channels received. A set top box 5′ is connected to the viewer's telephone line 6′. Alternatively, an analogue television 4′ can have an integrated “set top box” connected to the viewer's telephone line.

The interactive component of television viewing is facilitated by providing an information server 7′, operated by the broadcaster, which is coupled to the broadcasting studios to receive the broadcast signals (the server may be provided by one or more computers). The broadcast signals contain programme triggers which indicate the beginning and end of a programme (including commercials) and the identity of broadcast programmes. This enables the information server 7′ to be synchronised to the broadcasting studios 2′. When a viewer “interacts” with the television, information is sent from a set top box 5′ down the telephone line 6′, via a PSTN 8′, to the information server 7′.

If an advertisement is shown, viewers can register their interest in the product or service advertised, via their set top box 5′, by pressing a button on their television remote control 13′. The remote control may have a dedicated button which can be pressed to register an interest in an advertisement when it is being shown, so that very little effort is required on the part of the viewer. The set top box 5′ receives a signal from the remote control 13′ and this triggers the sending of a message to the Information Server 7′.

Each set top box has an individual identifier which is included in the sent message, and the location and identity of viewers registering an interest can be determined from the identifiers of the set top boxes. The information server 7′ then collates the information about which viewers have responded to the advertisement in substantially real time, to form a profile of the demographics and/or location of the audience.

If the initial advertisement is a “head” advertisement from a “head and tail” pair, the Information Server automatically instructs the studio 2′ as to which “tail” is to be selected, on the basis of the profile formed.

This profile is also relayed to a merchant 9′, for example via the Internet 10′. The merchant can then decide where demand for the advertised products is likely to increase, and tailor local provision of those products accordingly.

It is of course also possible for the set top box to communicate to the information server 7′ the simple fact that an advertisement has been shown on a particular television set, regardless of whether the viewer expresses an interest in the advertised products. This can be done automatically.

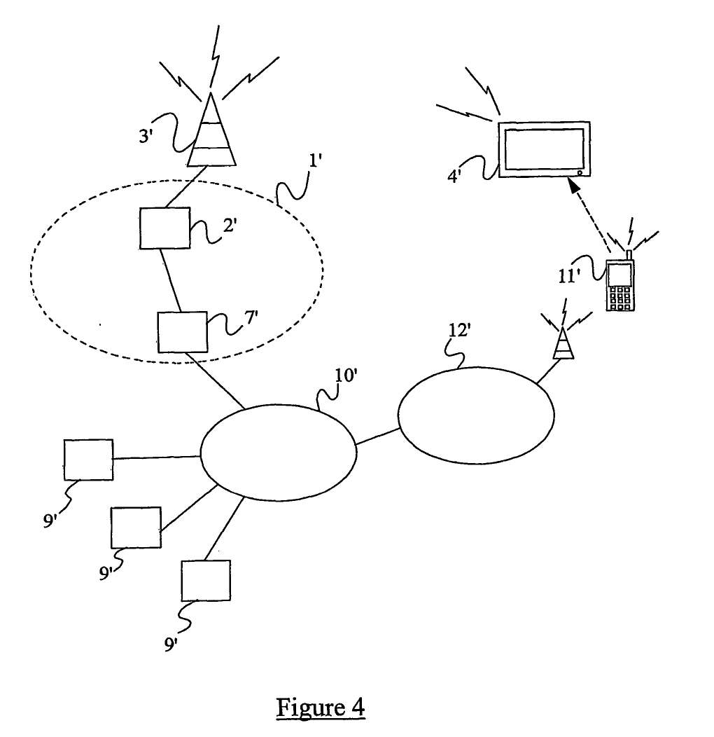

FIG. 4 illustrates another system for providing interactivity to analogue television, and does not require the use of a set top box. Like numerals refer to like components from FIG. 3. The television corporation 1′ broadcasts programmes on a number of different terrestrial television channels from a central studio or studios 2′ using a set of transmitters 3′. These broadcasts may comprise digital or analogue signals. Televisions 4′ receive the broadcast channels in the usual manner.

The interactive component of television viewing is again facilitated by the provision of an information server 7′ coupled to the broadcasting studios to receive the broadcast signals so as to be synchronised with those signals. The information server is coupled to the Internet 10′.

In order to participate in an interactive broadcast, a viewer must also be able to access the Internet 10′. In the example shown in FIG. 4, this is done with a wireless device 11′ such as a mobile telephone, communicator, or PDA, via a mobile telecommunication access network 12′ to which the terminal user subscribes. Existing mobile phone networks (e.g. GSM) may have this functionality. However, Internet access is being greatly enhanced with the introduction of new services such as GPRS and new networks such as UMTS. Alternatively, the viewer may access the Internet via a standard telephone or cable modem from an ordinary PC.

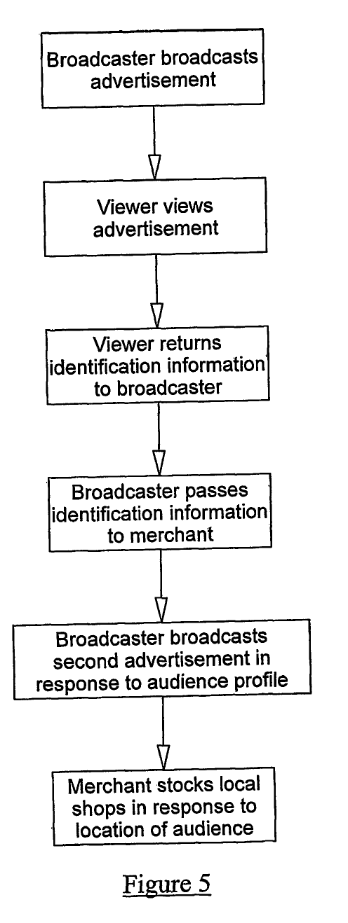

If an advertisement is shown, viewers can register their interest in the product advertised with the information server 7′ via the Internet 10′. The information server is also able to pass data back to the wireless device 11′, for example prompting audience members to register their interest in a particular product. The information server 7′ is again also connected to an external merchant 9′ via the Internet, and generates an audience profile of those audience members who have registered interest in a product. The profile is communicated by the information server 7′ to the merchant 9′ and/or used to select a tail where the initial advertisement is the head of a head and tail pair. The method is further illustrated in the flow diagram of FIG. 5.

Operators of existing mobile telephone networks already know the Location Area (i.e. the group of broadcast cells) in which the user of a mobile subscriber is located. Future networks will be able to pin-point the location of subscribers with a much greater degree of accuracy. By making this location information available to the information server 7′ and thus the merchant 9′ in respect of those viewers who respond, it is possible to build up a profile of the location of viewers watching the advertisement, as with the system of FIG. 3.

It will be appreciated that various modifications can be made to the embodiments of FIGS. 3 and 4 without departing from the scope of the present invention. For example, advertisements could be broadcast using interactive radio rather than television.

The interaction between audience members and the broadcaster or merchant could also be achieved using text messaging (for example the Short Message Service (SMS) of GSM) using conventional mobile networks.

1. A method of enabling a television viewer to interact with a television programme and comprising the steps of:
broadcasting a television signal corresponding to said television programme; and
sending messages from an information server to a mobile wireless terminal operated by said television viewer and/or receiving messages at the information server sent from said wireless terminal, the sending and/or receipt of messages being synchronised at the information server with the broadcast television signal.

2. A method according to claim 1, wherein the mobile wireless terminal is able to communicate with and via a mobile telecommunications network.

3. A method according to claim 1 or 2, wherein said messages are sent between the information server and the mobile wireless terminal using Internet Protocol (IP).

4. A method according to claim 3, wherein a viewer establishes an initial connection to the information server using a URL.

5. A method according to claim 4, wherein the information server performs a redirection of a viewer URL request to another web server.

6. A method according to claim 5, wherein the web server to which the request is redirected is operated by a commercial organisation sponsoring or associated with a current television broadcast.

7. A method according to claim 2, wherein said messages are sent between the information server and the mobile wireless terminal using text messaging.

8. A method according to any one of the preceding claims, wherein synchronisation between the information server and the broadcast television signal is achieved automatically, by including triggers in the broadcast signal.

9. A method according to any one of the preceding claims, wherein the messages sent to the mobile terminal depend upon the location of the mobile terminal.

10. A method according to claim 9 when appended to claim 2, wherein the information server is informed of the location of the mobile terminal by the mobile telecommunications network.

11. A method according to any one of the preceding claims and comprising displaying selectable options on the mobile terminal, with selection messages being sent from the terminal to the information server via the mobile telecommunications network in synchronisation with the television broadcast.

12. A method according to claim 11, wherein the signal broadcast to the viewer depends upon the selection(s) made by the viewer.

13. A method according to any one of the preceding claims, wherein the mobile terminal functions as a television remote control.

14. A method according to claim 13, wherein addresses for connecting to the information server are associated with respective programme selection buttons of the mobile terminal, such that when a key is pressed to select a particular channel, the terminal will establish a connection to the corresponding URL.

15. A method according to claim 13 or 14, wherein the mobile terminal communicates with a television via a bidirectional local wireless link.

16. A method according to claim 1, wherein the mobile terminal communicates with the information server via a computer, the mobile terminal communicating with the computer via a local wireless link, and the computer communicating with the information server via the Internet.

17. A method of accessing a www page relevant to a broadcast television programme, the method comprising:
selecting a television channel by pressing a button or buttons of a wireless communication terminal to cause a channel selection signal to be sent from the terminal to a television;
the button press(es) causing the mobile terminal to establish a connection to an information server via a mobile telecommunication network, and transferring the relevant www page from the server to the terminal over said connection.

18. Apparatus for enabling a television viewer to interact with a television programme and comprising:
an information server synchronised to one or more television broadcasts; and
means for exchanging information between the information server and a multiplicity of mobile wireless terminals via a mobile telecommunications system.

19. A method of determining a profile of the audience of a broadcast advertisement, the method comprising:
enabling audience members to send their identity or location to the broadcaster of the advertisement or to a merchant in substantially real time when viewing or listening to the advertisement; and
automatically collecting and processing sent information to provide a profile of the audience.

20. A method according to claim 19, wherein the collection of sent information is synchronised to the broadcast advertisement.

21. A method according to claim 19 or 20, wherein the advertisement is broadcast using a satellite, cable or terrestrial TV broadcast and audience members send their identity or location to the merchant or broadcaster through an interactive feedback channel via a mobile wireless terminal and a mobile network.

22. A method according to claim 21, wherein the mobile network is a GSM or PDC network providing a packet switched service.

23. A method according to claim 21 or 22, wherein the interactive feedback channel uses IP as the transport protocol.

24. A method according to claim 23, wherein the mobile wireless terminals use WAP or i-mode to communicate their identities or locations to the broadcaster of the advertisement or to a merchant.

25. A method according to any one of claims 21 to 24, wherein the location of an audience member may be determined from the location of the mobile terminal in the network.

26. A method according to claim 19, wherein the advertisement is broadcast using a satellite, cable or terrestrial TV broadcast and audience members send their identities or locations to the merchant or broadcaster through an interactive feedback channel via a telephone connection between an audience member's set top box and a broadcaster or merchant.

27. A method according to claim 19, wherein the advertisement is broadcast using a satellite, cable or terrestrial TV broadcast and audience members send their identity or location to the merchant or broadcaster through an interactive feedback channel via the Internet between an audience member's set top box and a broadcaster or merchant.

28. A method according to claim 26 or 27, wherein each set top box has associated with it a unique identifier which is communicated to the broadcaster or merchant, and the identity or location of each said audience member is determined from the identifier of the set top box.

29. A method according to any one of claims 19 to 28, wherein an audience member triggers the sending of a message containing his or her identity and/or location to the broadcaster or merchant.

30. A method according to any one claims 19 to 28, wherein the identity or location of an audience member is communicated automatically to the merchant each time the advertisement is broadcast.

31. A method according to any one claims 19 to 30, wherein the profile is a location profile.

32. A method according to any one claims 19 to 30, wherein the profile is a demographic profile.

33. A method of advertising products or services, comprising:
broadcasting a first advertisement;
obtaining a profile of the audience of the first advertisement in substantially real time using the method of any one of claims 19 to 32;
selecting a second advertisement based on the profile of the audience of the first advertisement; and
broadcasting the second advertisement.

34. A method of distributing products and services, comprising:
broadcasting an advertisement for the products or services;
determining the location of the audience of the advertisement in substantially real time using the method of any of claims 19 to 32; and
providing the advertised products or services in locations indicated by the location of the audience of the broadcast advertisement.
